(19) United States
(12) Patent Application Publication
(10) Pub. No.: US 2011/0080885 A1
(43) Pub. Date: Apr. 7, 2011

(54) APPARATUS AND METHOD FOR MANAGEMENT OF EXTENSION CARRIER IN BASE STATION

(75) Inventors: Jae Sheung SHIN, Daejeon (KR); Hyun Seo PARK, Daejeon (KR); Kyung Sook KIM, Daejeon (KR); Pyeong Jung SONG, Daejeon (KR); Yeon Seung SHIN, Daejeon (KR)

(73) Assignee: Electronics and Telecommunications Research Institute, Daejeon (KR)

(21) Appl. No.: 12/898,409

(22) Filed: Oct. 5, 2010

(30) Foreign Application Priority Data
Oct. 5, 2009 (KR) 10-2009-0094292
Jul. 28, 2010 (KR) 10-2010-0072659

(51) Int. Cl. H04W 72/04; H04W 28/00

(52) U.S. Cl. 370/329; 455/450

(57) ABSTRACT

Provided are an extension carrier managing apparatus of a base station and a method thereof. When an extension carrier is to be added in a terminal, the extension carrier managing apparatus may compare propagation characteristics of available extension carriers with a propagation characteristic of a stand-alone carrier being used by a terminal, and may set an extension carrier having a transmission range being less than or equal to the stand-alone carrier, and has a penetration loss being greater than or equal to the stand-alone carrier and thus, may set the extension carrier where a coverage-hole does not occur.

### CROSS-REFERENCE TO RELATED APPLICATION(S)

This application claims the benefit of Korean Patent Application No. 10-2009-0094292 and of Korean Patent Application No. 10-2010-0072659, respectively filed on Oct. 5, 2009 and Jul. 28, 2010, in the Korean Intellectual Property Office, the disclosures of which are incorporated herein by reference.

### BACKGROUND

1. Field of the Invention

The present invention relates to a method of managing and activating an extension carrier used by a base station in a Long Term Evolution (LTE)-advanced system.

2. Description of the Related Art

A carrier in a Long Term Evolution (LTE)-advanced system may be classified into a backward compatible carrier, a non-backward compatible carrier, and an extension carrier.

The backward and the non-backward compatible carrier may be stand-alone carriers that may be used alone. Channels of all physical (PHY) layers used by an LTE system and the LTE-advanced system may be provided by the carriers.

The extension carrier may not be used alone and may be used as one of extended elements of the stand-alone carrier that may already be connected to a terminal. Therefore, the extension carrier may not include any PHY layer control channel, for example, PDCCH, PHICH, and PCFICH, used for transmitting information including a hybrid automatic repeat request (HARQ) feedback of an uplink data and the like, and may not include various control information that may be used for encoding/decoding data during downlink data transmission. The extension carrier may not broadcast system information, such as an MIB, an SIB, and the like, and may not transmit paging via the extension carrier to decrease overhead and to improve a capacity and performance of the carrier. A variety of information that may not be included in the extension carrier may be transmitted to the terminal via the stand-alone carrier already being accessed by the terminal.

Basically, the LTE and the LTE-advanced system may include a data channel that may transmit data to a PHY layer and a control channel that may transmit information associated with a location of an assigned radio resource, demodulating and coding information, and the like to enable the terminal to receive corresponding data. Therefore, the terminal may receive data transmitted via the data channel based on the information of the control channel, and may perform demodulating and decoding to process desired data. However, the extension carrier may only include the data channel that may transmit only data without control information and thus, special attention may be needed to enable the terminal to receive data without any difficulty and to perform demodulating and decoding to process the data.

The LTE-advanced system may use a radio resource of a wide bandwidth, having a maximum bandwidth of about 100 MHz, to improve a performance and thus, may use a carrier aggregation that may collect and manage multiple carriers of various bandwidths based on different units, such as 10 MHz, 20 MHz, 30 MHz, and 40 MHz. However, when the bandwidth of 100 MHz is not continuously allocated in a single band due to lack of a frequency resource, carriers that may be allocated in different spectrum bands may be collected for use. For example, carriers of 20 MHz available in a band of 800 to 900 Mhz, carriers of 40 MHz available in a band of 2.5 GHz, and carriers of 40 MHz available in a band of 3.5 GHz may be collected and may be aggregated to use a radio resource of a logically continuous bandwidth of 100 MHz. This may be referred to as a non-contiguous carrier aggregation scheme. Carriers used for the non-contiguous carrier aggregation scheme may have different propagation conditions since a frequency characteristic is different for each spectrum band. In this example, the propagation condition may include a transmission range, a penetration loss, a reflection effect, and the like.

The carriers provided by the LTE-advanced system may be defined, based on a characteristic, as the backward compatible, the non-backward compatible, and the extension carrier, and the terminal may suffer from a coverage-hole where only the extension carrier has access, depending on a carrier management condition.

For example, when the extension carrier has a transmission range greater than the stand-alone carrier and has less penetration loss than the stand-alone carrier, the coverage-hole may occur, the coverage-hole being outside the stand-alone carrier and being accessible by the extension carrier.

In the coverage-hole, the terminal may not receive any control information from a base station, and may only receive data transmitted via the data channel. In the coverage-hole, however, the terminal may receive data without separate control information based on a predetermined period and modulation and coding scheme, such as a semi-persistent scheduling service. The terminal may partly perform a function, such as measuring of a reference signal received via the extension carrier to report the measured reference signal to the base station, in the coverage-hole. Therefore, the terminal may not be outside a service area of the base station.

However, functions of the terminal, such as setting of a new radio bearer, a correcting of an existing radio bearer, receiving of HARQ feedback with respect to the uplink data, and the like may be performed based on information of the PHY control channel and thus, the functions may not be performed by the terminal in the coverage-hole.

### SUMMARY

An aspect of the present invention provides an apparatus and method of managing an extension carrier by a base station.

Another aspect of the present invention provides a method of managing and activating an extension carrier used in a base station of an LTE-advanced system.

Another aspect of the present invention also provides an apparatus and method of managing, by a base station, an extension carrier to prevent a coverage-hole.

Another aspect of the present invention also provides a method of preventing a coverage-hole by effectively selecting, by a base station, a stand-alone carrier that may transmit control information of an extension carrier, instead of the extension carrier.

According to an aspect of the present invention, there is provided an extension carrier managing apparatus of a base station, the apparatus including a carrier controller to compare propagation characteristics of available extension carriers with a propagation characteristic of a stand-alone carrier being used by a terminal, and to set an extension carrier where a coverage-hole between the extension carrier and the stand-alone carrier does not occur, when an extension carrier is to be added in the terminal.

According to an aspect of the present invention, there is provided an extension carrier managing method of a base station, the method including determining whether to add an extension carrier to a terminal, and setting an extension carrier where a coverage-hole does not occur by comparing propagation characteristics of available extension carriers with a propagation characteristic of a stand-alone carrier being used by the terminal when the determination determines to add the extension carrier in the terminal.

According to an aspect of the present invention, there is provided an extension carrier managing method of a base station, the method including managing at least one stand-alone carrier having a propagation condition similar to an extension carrier or having a superior propagation condition compared with the extension carrier, when the extension carrier is provided to a terminal.

According to an aspect of the present invention, there is provided an extension carrier managing method of a base station, the method including enabling a terminal that accesses a stand-alone carrier having a propagation condition similar to a extension carrier or having a superior propagation condition compared with the extension carrier, to use the extension carrier.

According to an aspect of the present invention, there is provided an extension carrier managing method of a base station, the method including accessing a stand-alone carrier having a propagation condition similar to the extension carrier or having a superior propagation condition compared with the extension carrier, when the extension carrier is provided to a terminal.

Additional aspects, features, and/or advantages of the invention will be set forth in part in the description which follows and, in part, will be apparent from the description, or may be learned by practice of the invention.

### EFFECT

According to embodiments, an extension carrier managing apparatus included in a base station and method thereof may set an extension carrier having a transmission range less than or equal to a stand-alone carrier being used by a terminal and having a penetration loss greater than or equal to the stand-alone carrier.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a configuration of a base station managing an extension carrier according to an embodiment of the present invention;

FIG. 2 is a flowchart illustrating a process of setting a carrier between a terminal and a base station according to an embodiment of the present invention; and

FIG. 3 is a flowchart illustrating a process where a base station manages an extension carrier according to an embodiment of the present invention.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

Embodiments of the present invention may describe an extension carrier managing apparatus and method that may prevent a coverage-hole, with reference to the figures.

The extension carrier managing method where the base station manages an extension carrier to prevent the coverage-hole may be classified into three operations.

A first operation may manage at least one stand-alone carrier having a propagation condition similar to the extension carrier or having a superior propagation condition compared with the extension carrier.

Specifically, a carrier having the same transmission range, the same penetration loss, the same reflection effect, and the like to the extension carrier or a carrier having a superior propagation condition compared with the extension carrier may be allocated as a stand-alone carrier to enable the stand-alone carrier to transmit information of the extension carrier, instead of the extension carrier. A carrier having a lowest spectrum band is allocated to be used as the stand-alone carrier and thus, a coverage-hole may be overcome.

However, the first operation may be a limit condition for a carrier management of a system and thus, may obstruct free management of an operator.

Even when the system provides a stand-alone carrier satisfying the condition of the first operation, a coverage-hole may still exist depending on a stand-alone carrier being already connected to the terminal when a plurality of stand-alone carriers exist in the system.

Therefore, to overcome the coverage-hole that may occur in the first operation, a second operation may enable a terminal that may access a stand-alone carrier having a similar propagation to the extension carrier or having a superior propagation compared with the extension carrier, to use the extension carrier.

However, the second operation may not select the extension carrier, depending on the stand-alone carrier being accessed by the terminal.

Therefore, when the base station allocates an extension carrier to the terminal, to overcome a limit in using the extension carrier, a third operation may change an access to access a new stand-alone carrier having a similar propagation condition to the extension carrier or having a superior propagation condition compared with the extension carrier, or may establish an additional access to the new stand-alone carrier.

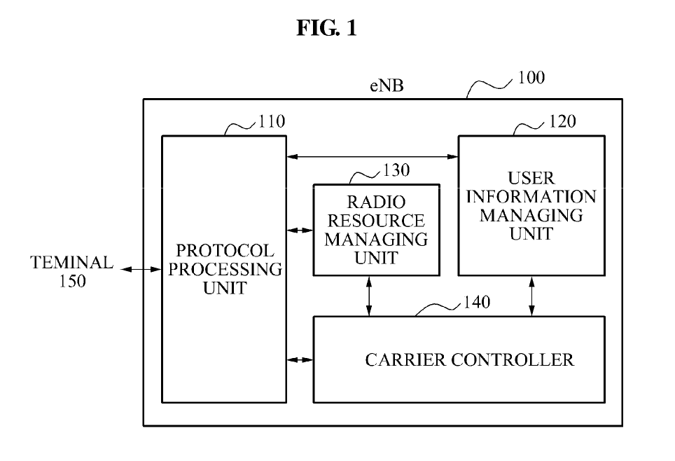

FIG. 1 illustrates a configuration of a base station managing an extension carrier 100 according to an embodiment of the present invention.

Referring to FIG. 1, the base station 100 may include a protocol processing unit 110, a user information managing unit 120, a radio resource managing unit 130, and a carrier controller 140.

The protocol processing unit 110 may provide a protocol layer function to communicate with a protocol layer, for example, a Physical (PHY) layer, Media Access Control (MAC) layer, a Radio Link Control (RLC) layer, a Radio Resource Control (RRC) layer, and the like, and to communicate with core network nodes, for example, a Serving gateway (SGW), a Mobility Management Entity (MME), and the like. The protocol layer may be used for performing wireless transmission and reception of a signal message and user data with a terminal 150.

The user information managing unit 120 may maintain and manage state information of the terminal 150 that receives a service in an area of the base station 100 and Quality of Service (QoS) information associated with a desired QoS for the terminal 150.

The radio resource managing unit 130 may maintain and manage a variety of information including a number of available carriers, frequency characteristic information of each carrier, and the like. The radio resource managing unit 130 may manage a radio resource state of a radio resource used by a terminal being operated in each carrier.

The carrier controller 140 may manage information associated with a carrier being used by each terminal, may receive, from the radio resource managing unit 130, state information of available radio resources in a corresponding carrier, and may receive, from the user information managing unit 120, the QoS information of the terminal to determine whether to add an extension carrier or to release an current extension carrier.

When the determination determines to add the extension carrier, the carrier controller 140 may compare propagation characteristics of available extension carriers with a propagation characteristic of a stand-alone carrier being used by the terminal 150, and may set an extension carrier where a coverage-hole between the extension carrier and the stand-alone carrier does not occur.

When the extension carrier where the coverage-hole between the extension carrier and the stand-alone carrier being used by the terminal 150 does not occur is not included in the available extension carriers, the carrier controller 140 may change an access to access a new stand-alone carrier that may select an extension carrier where a coverage-hole does not occur or may establish an additional access to the new stand-alone carrier. The carrier controller 140 may set the extension carrier where the coverage-hole between the extension carrier and the changed or added the new stand-alone carrier does not occur.

An extension carrier managing method performed by the base station configured based on the above described embodiments may be described with reference to figures.

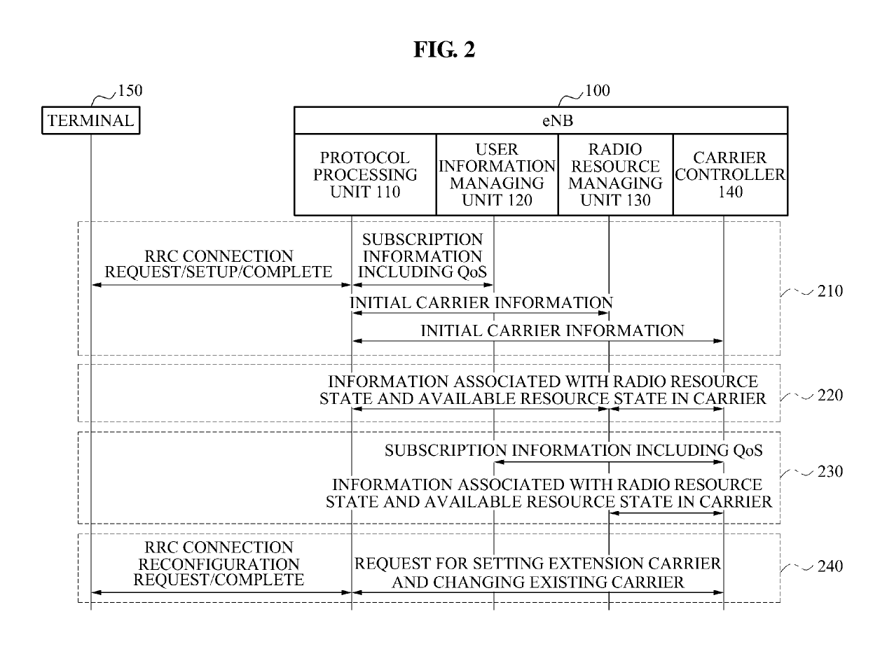

FIG. 2 illustrates a process of setting a carrier between the terminal 150 and the base station 100 according to an embodiment of the present invention.

Referring to FIG. 2, the terminal 150 and the base station 100 set an initial carrier in operation 210. In the setting of the initial carrier, the terminal 150 accesses a network, and a bearer that may transmit a signal message and data via a carrier used for accessing the network may be set. An RRC layer of the terminal 150 and an RRC layer of the base station 100 may exchange a message, such as an RRC connection request message, an RRC setup message, an RRC complete message, and the like. While the RRC connection request message and the RRC setup message are processed, the base station 100 may obtain subscription information of the terminal 150 and QoS information associate with a QoS for the terminal 150, and the like, from core network nodes, such as an MME and the like. Therefore, in the setting of the initial carrier, the user information managing unit 120 may obtain and store subscription information including the QoS information of the terminal 150. The radio resource managing unit 130 and the carrier managing unit 140 may obtain carrier information associated with the initial carrier of the terminal 150.

In operation 220, the terminal 150 and the base station 100 may determine, using the radio resource managing unit 130, an available resource state and a radio resource state in the carrier being used by the terminal 150, while providing a service. The available resource state and the radio resource state may be provided to the carrier controller 140.

In operation 230, the terminal 150 and the base station 100 determines whether to add an extension carrier using the carrier controller 140.

In operation 240, when the determination in operation 230 determines to add the extension carrier, the terminal 150 and the base station 100 set the an extension carrier using the carrier controller 140, and setting information may be transmitted to the terminal 150 via a signal message, such as an RRC connection reconfiguration request, and the like.

In this example, the extension carrier where a coverage-hole between the extension carrier and a stand-alone carrier being accessed by the terminal 150 does not occur may be set among the available extension carriers. However, when characteristics of the available extension carriers and a characteristic of the stand-alone carrier being used by the terminal 150 are different, an access may be changed to access a new stand-alone carrier that may select an extension carrier where a coverage-hole does not occur, or an additional access to the new stand-alone carrier may be established.

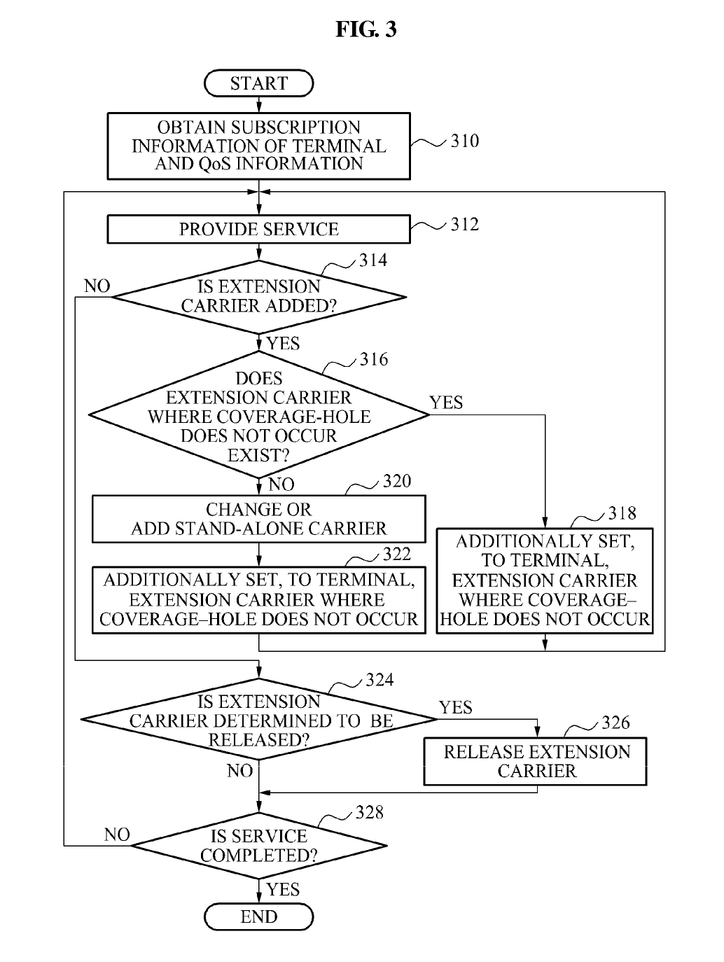

FIG. 3 illustrates a process where a base station manages an extension carrier.

Referring to FIG. 3, the base station 100 sets an initial carrier of a terminal accessing a network and obtains subscription information of the terminal and QoS information associated with a desired QoS for the terminal in operation 310.

In operation 312, the base station 100 provides a service to the terminal. In this example, the base station 100 may determine an available resource state and a radio resource state in a carrier used by the terminal, while providing the service.

In operation 314, the base station 100 determines whether to add an extension carrier, based on the available radio resource state in the carrier and the QoS information of the terminal.

When the determination in operation 314 determines to add the extension carrier, the base station 100 may determine whether an extension carrier where a coverage-hole does not occur exists among available extension carriers in operation 316.

When the determination in operation 316 determines that the extension carrier where the coverage-hole does not occur exists, the base station 100 may additionally set, to the terminal, the extension carrier where the coverage-hole does not occur in operation 318.

When the determination in operation 316 determines that the extension carrier where the coverage-hole does not occur does not exist, the base station 100 may change an access to access a new stand-alone carrier that may select an extension carrier where a coverage-hole between the extension carrier and the new stand-alone carrier does not occur, or may establish an additional access to the new stand-alone carrier, in operation 320. In operation 322, the base station 100 may additionally set the extension carrier where the coverage-hole between the extension carrier and the changed or added the new stand-alone carrier of operation 320 does not occur.

When the determination in operation 314 determines to not add the extension carrier, the base station 100 determines whether to release a current extension carrier being used by the terminal, in operation 324. In this example, the determination in operation 324 may determine to release the current extension carrier when a radio resource of the stand-alone carrier being accessed by the terminal satisfies the desired QoS for the terminal.

When the determination in operation 324 determines to release the current extension carrier, the base station 100 releases the corresponding extension carrier in operation 326. Conversely, when the determination in operation 324 determines to not release the current extension carrier, the base station 100 determines whether the service is completed in operation 328.

When the determination in operation 328 determines that the service is not completed, the base station 100 returns to operation 312. However, when the determination in operation 328 determines that the service is completed, the base station 100 terminates a corresponding algorithm.

The method according to the above-described embodiments of the present invention may be recorded in non-transitory computer readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. An apparatus of managing an extension carrier, in a base station, the apparatus comprising:
a carrier controller to compare propagation characteristics of available extension carriers with a propagation characteristic of a stand-alone carrier being used by a terminal, and to set an extension carrier where a coverage-hole between the extension carrier and the stand-alone carrier does not occur, when an extension carrier is to be added in the terminal.

2. The apparatus of claim 1, wherein the extension carrier where the coverage-hole does not occur has a transmission range being less than or equal to the stand-alone carrier, and has a penetration loss being greater than or equal to the stand-alone carrier.

3. The apparatus of claim 1, wherein, when the extension carrier where the coverage-hole between the extension carrier and the stand-alone carrier being used by the terminal does not occur is not included in the available extension carriers, the carrier controller changes an access to access a new stand-alone carrier or establishes an additional access to the new stand-alone carrier.

4. The apparatus of claim 3, wherein the carrier controller establishes an access to an extension carrier where a coverage-hole between the extension carrier and the new stand-alone carrier does not occur, after changing the access to access the new stand-alone carrier or after establishing the additional access to the new stand-alone carrier.

5. The apparatus of claim 3, wherein the new stand-alone carrier selects an extension carrier where a coverage-hole between the extension carrier and the new stand-alone carrier does not occur.

6. The apparatus of claim 1, further comprising:
a protocol processing unit to provide a protocol layer function that performs transmission and reception of data with the terminal based on a radio communication;
a user information managing unit to manage state information of the terminal and Quality of Service (QoS) information associated with a desired QoS, using the protocol processing unit; and
a radio resource managing unit to manage a number of available carriers, characteristic information of each carrier, and a resource state of each carrier,
wherein the carrier controller determines whether to add the extension carrier based on the resource state of a carrier being used by the terminal and QoS for the terminal.

7. A method of managing an extension carrier, in a base station, the method comprising:
determining whether to add an extension carrier to a terminal; and
setting an extension carrier where a coverage-hole does not occur by comparing propagation characteristics of available extension carriers with a propagation characteristic of a stand-alone carrier being used by the terminal when the determination determines to add the extension carrier in the terminal.

8. The method of claim 7, further comprising:
changing an access to access a new stand-alone carrier or establishing an additional access to the new stand-alone carrier, when the extension carrier where the coverage-hole between the extension carrier and the stand-alone carrier being used by the terminal does not occur is not included in the available extension carriers; and
establishing an access to an extension carrier where a coverage-hole between the extension carrier and the new-stand alone carrier does not occur, after changing the access to access to the new stand-alone carrier or after establishing the additional access to the new stand-alone carrier.

9. A method of managing an extension carrier, in a base station, the method comprising:
managing at least one stand-alone carrier having a propagation condition similar to an extension carrier or having a superior propagation condition compared with the extension carrier, when the extension carrier is provided to a terminal.

10. A method of managing an extension carrier, in a base station, the method comprising:
enabling a terminal that accesses a stand-alone carrier having a propagation condition similar to a extension carrier or having a superior propagation condition compared with the extension carrier, to use the extension carrier.

11. A method of managing an extension carrier, in a base station, the method comprising:
accessing a stand-alone carrier having a propagation condition similar to the extension carrier or having a superior propagation condition compared with the extension carrier, when the extension carrier is provided to a terminal.
